(19) United States
(12) Patent Application Publication
(10) Pub. No.: US 2017/0232478 A1
(43) Pub. Date: Aug. 17, 2017

(54) AUTOMATIC WEIGHING AND SORTING APPARATUS FOR BATTERY ELECTRODE SHEETS

(71) Applicants: JIANGSU HUADONG INSTITUTE OF LI-ION BATTERY CO., LTD., Suzhou (CN); TSINGHUA UNIVERSITY, Beijing (CN)

(72) Inventors: Yong Yang, Suzhou (CN); Hong-Sheng Zhang, Suzhou (CN); Jian-Jun Li, Beijing (CN); Xiang-Ming He, Beijing (CN); Guo-Hua Li, Suzhou (CN); Shu-Cheng Huang, Suzhou (CN); Yong-Cun Wu, Suzhou (CN); Li Wang, Beijing (CN); Yu-Ming Shang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/587,241

(22) Filed: May 4, 2017

Related U.S. Application Data
(63) Continuation of application No. PCT/CN2015/093284, filed on Oct. 30, 2015.

(30) Foreign Application Priority Data
Nov. 6, 2014 (CN) 201410618514.3

(51) Int. Cl. B07C 5/18; B07C 5/36

(52) U.S. Cl. CPC B07C 5/18; B07C 5/362

(57) ABSTRACT

An automatic weighing and sorting apparatus for battery electrode sheets is provided. The automatic weighing and sorting apparatus includes a conveying device, a weighing device, and a sorting device. The conveying device is configured to transfer a number of battery electrode sheets to the weighing device. The weighing device is configured to get a weight of each of the number of battery electrode sheets. The sorting device is configured to sort the number of battery electrode sheets based on the weight of each of the number of battery electrode sheets.

### CROSS-REFERENCE TO RELATED APPLICATIONS

This application claims all benefits accruing under 35 U.S.C. §119 from China Patent Application No. 201410618514.3, filed on Nov. 6, 2014 in the State Intellectual Property Office of China, the contents of which are hereby incorporated by reference. This application is a continuation of international patent application PCT/CN2015/093284 filed Oct. 30, 2015, the content of which is hereby incorporated by reference.

### FIELD

The present disclosure relates to the field of lithium ion battery, and particularly relates to an automatic weighing and sorting apparatus for battery electrode sheets.

### BACKGROUND

Lithium-ion battery based on stack technology has relied on die-cutting machines to produce electrode sheets. The traditional die-cutting machine comprises an automatic volume retract device, a servo pulling device, a driving system, a photoelectric sensing and automatic correction device, and an infrared automatic safety sensor.

After the electrode sheets are produced by the die-cutting machine, the sheets must be manually weighed and sorted. This process, however, is time-consuming, inefficient, and prone to cause damage to the electrode sheets from manually handling the electrode sheets.

### BRIEF DESCRIPTION OF THE DRAWINGS

FIG. 1 shows a schematic view of one embodiment of an automatic weighing and grading apparatus for battery electrode sheets.

FIG. 2 shows a schematic top view of one embodiment of an automatic weighing and grading apparatus for battery electrode sheet.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

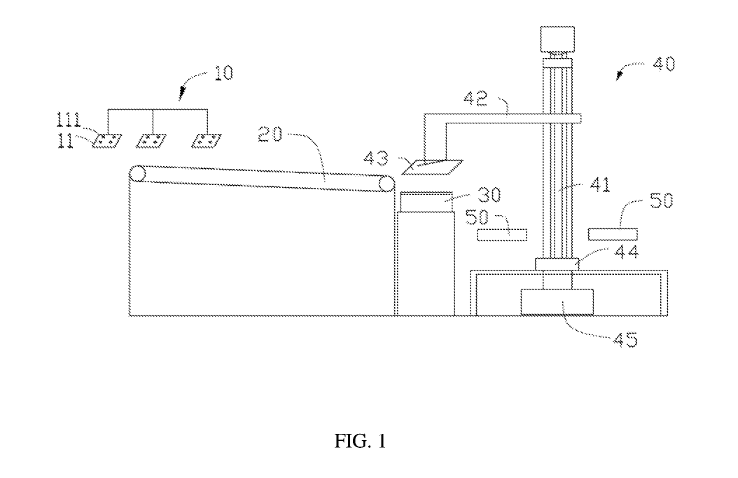

With reference to FIG. 1, an embodiment of an automatic weighing and sorting apparatus for battery electrode sheets comprises a suction device 10, a conveying device 20, a weighing device 30, and a sorting device 40 arranged in line as an assembly line. The suction device 10 is configured to suck or grip the battery electrode sheet by suction and place the battery electrode sheet onto the conveying device 20. The conveying device 20 is provided between the suction device 10 and the weighing device 30, and used to transfer the battery electrode sheet to the weighing device 30. The suction device 10 and the conveying device 20 can be used as a supply means to convey the plurality of battery electrode sheets to the weighing device 30. The weighing device 30 is used to accurately weigh each of the plurality of battery electrode sheets. The sorting device 40 is disposed adjacent to the weighing device 30. The sorting device 40 is configured to sort the plurality of battery electrode sheets on the weighing device 30 based on the different weights of each of the plurality of battery electrode sheets, and place them in different sorting stations.

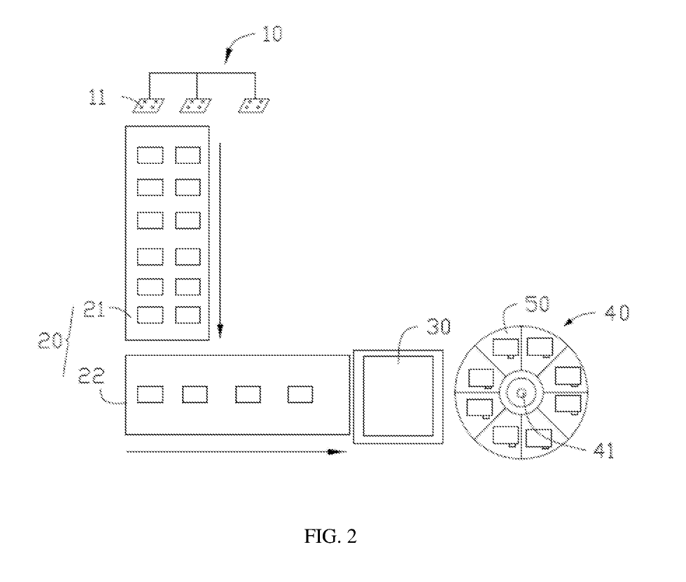

Referring also to FIG. 2, the suction device 10 comprises at least one suction cup 11 for gripping the plurality of battery electrode sheets by suction. In one embodiment, the suction can be generated by reduced air pressure over part of a surface by applying at least a partial vacuum using, for example, a vacuum device. A size of the suction cup 11 can be selected according to the size of the electrode sheet, ensuring that the suction cup 11 can grip and hold at least one of the plurality of battery electrode sheets.

The suction cup 11 can have a surface with a plurality of micropores 111 formed on the surface to grip the battery electrode sheet. In one example, the micropores 111 appear as microscopic craters functioning as micro suction cups capable of sticking onto smooth surfaces without adhesive. Thus, the plurality of micropores 111 can be used to conveniently adhere to the plurality of battery electrode sheets. Furthermore, the material of the suction cup 11 can aid in adhering to and gripping the battery electrode sheets. The micropores can be through holes. In one example, the through holes can be connected to a gas tube, and using gas to generate attraction force to attract and grip the battery electrode sheets through the through hole. Thus, the specific surface area of the plurality of micropores 111 can be increased, and the adsorption force of the plurality of battery electrode sheets can also be increased. The adsorbed pressure can be relatively reduced in order to reduce the surface deformation of the plurality of battery electrode sheets during the adsorption process, and improve the pass rate of the battery electrode sheets. In one embodiment, the suction device 10 comprises three suction cups 11 to draw three battery electrode sheets simultaneously.

The suction device 10 maybe an optional device. Instead, the plurality of battery electrode sheets can be directly placed on the conveying device 20 and delivered to the weighing device 30 via the conveying device 20.

As shown in FIG. 2, the conveying device 20 transfers the plurality of battery electrode sheets to the weighing device 30. In one embodiment, the conveying device 20 includes a first guide rail 21 and a second guide rail 22. As shown, the conveying direction of the first guide rail 21 can be perpendicular to the second guide rail 22. However, the orientation of the first guide rail 21 can be at any angle with respect to the second guide rail 22 including along a same line, and at different altitudes or heights. The first guide rail 21 comprises a first end and a second end opposite to the first end, and the first end is adjacent to the suction device 10 for receiving the plurality of battery electrode sheets from the suction device 10. As shown, the suction device 10 can simultaneously transfer three battery electrode sheets to the first guide rail 21, and the three battery electrode sheets are arranged side by side on the first guide rail 21.

The second guide rail 22 comprises a third end and a fourth end, and the third end of the second guide rail 22 is connected to the second end of the first guide rail 21, in order to receive the plurality of battery electrode sheets from the first guide rail 21. The second guide rail 22 is perpendicular to the first guide rail 21, in order to place the battery electrode sheets from the first guide rail 21 onto the second guide rail 22 in a single line of battery electrode sheets. Thus, the battery electrode sheets are transferred from the second guide rail 22 onto the weighing device 30 in series. However, it is understood that the first guide rail 21 and the second guide rail 22 can be formed at an angle, so long as the plurality of battery electrode sheets on the first guide rail 21 is sequentially transferred to the second guide rail 22. Thus, the battery electrode sheets can be weighed one by one, and the efficiency can be improved. In one embodiment, height of the second guide rail 22 exhibits a tendency to decrease from the third end to the fourth end in the conveying direction. A slope angle between a transfer surface of the second guide rail 22 and the horizontal plane is in a range from about 150° to about 170°. With a gentle slope angle of the second guide rail 22, the plurality of battery electrode sheets can be conveniently transferred to the weighing device 30, and the conveying process can be relaxed to achieve a soft landing, which reduces the likelihood of damaging the plurality of battery electrode sheets.

The weighing device 30 is located adjacent to but spaced from the fourth end of the second guide rail 22. Thus, the plurality of battery electrode sheets can be safely transferred from the second guide rail 22 to the weighing device 30. Furthermore, a weighing surface of the weighing device 30 can be at a lower altitude or height than the conveying surface of the second guide rail 22, as discussed in detail below. Therefore, the plurality of battery electrode sheets can be smoothly transferred to the second guide rail 22 under the transmission of the second guide rail and the gravity of the battery electrode sheet. The weighing device 30 can be spaced from the conveying device 20 at a distance of about 1 mm to about 2 mm. Specifically, the distance between the weighing device 30 and the fourth end of the second guide rail 22 can range from about 1 mm to about 2 mm.

In one embodiment, a height difference between transfer surface of the second guide rail 22 and weighing surface of the weighing device 30 can range from about 1 mm to about 10 mm. The height difference between the second guide rail 22 and the weighing device 30 allows the plurality of battery electrode sheets to smoothly and automatically transfer from the transfer surface of the second guide rail 22 to the weighing face of the weighing device 30. The battery electrode sheet can transfer to a central portion of the weighing surface the weighing device 30. Thus, the accurate weighing and the accurate positioning can be improved. Furthermore, the weighing device 30 can further comprise an induction positioning device (not shown) for positioning and fixing the plurality of battery electrode sheets on the weighing surface. In one embodiment, the weighing device 30 can be a balance scale with an accuracy of one ten thousandth. Thus the accuracy of the weight can be dramatically improved, and the consistency of the plurality of battery electrode sheets can be improved.

In one embodiment, the sorting device 40 comprises a column guide 41, a bracket 42, a microporous suction cup 43, a rotation device 44, and an automatic control device 45. The rotation device 44 is capable of rotating in a counterclockwise or clockwise direction, in order to select the place path of the battery electrode sheet. The column guide 41 is located on the angle rotation device 44, and can be rotated with the rotation device 44. The bracket 42 can be placed on an outer surface of the column guide 41. In one embodiment, a first end of the bracket 42 is connected to the rotation device 44 and a second end extends toward the weighing device 30. Furthermore, the extending direction can be parallel to the weighing surface, and the second end suspended above the weighing surface. The microporous suction cup 43 is connected to the second end of the bracket 42. The microporous suction cup 43 can be rotated by the rotation device 44, and transfer the battery electrode sheet into different sorting stations 50. The automatic control device 45 is used to read the weight of the battery electrode sheet, drive the rotation device 44 to rotate to place the plurality of battery electrode sheets in different sorting stations 50. The automatic control device 45 can be a computer or other intelligent device.

The plurality of sorting stations 50 can be distributed around the rotation device 44, and the carrying surface of the sorting station 50 is lower than the weighing surface. Thus the plurality of battery electrode sheets can be efficiently and quickly transferred to the sorting station 50, the work of the microporous suction cup 43 can be reduced, and the energy consumption can be reduced. Each sorting station 50 can be used to carry the battery electrode sheets having a same weight. Therefore, the plurality of battery electrode sheets can be sorted.

Furthermore, the column guide 41 can be raised or lowered by a pneumatic device (not shown). Thus, the bracket 42 and the microporous suction cup 43 can be raised or lowered following the column guide 41. The microporous suction cup 43 can grip the plurality of battery electrode sheets, transfer them, and sort them.

The first guide rail 21 and the second guide rail 22 can be further equipped with a steel bar (not shown) for removing dust and burrs from the plurality of battery electrode sheets.

The sorting stations 50 can also be integrated with the rotation device 44. For example, the sorting stations 50 are located on the rotation device 44 and surround the column guide 41. The sorting stations 50 can be rotated with the rotation of the rotation device 44.

When the weighing device 30 acquires the weight of the battery electrode sheet, the measured weight information is transmitted to the automatic control device 45. The automatic control device 45 drives the rotation device 44 to rotate a certain angle based on the measured weight information. The sorting station 50 corresponding to the weight information can be rotated adjacent to the weighing device 30. The bracket 42 and the microporous suction cup 43 can draw the battery electrode sheet, and transfer the battery electrode sheet to the sorting station 50. Therefore, the plurality of battery electrode sheets can be accurately sorted.

The automatic weighing and sorting apparatus for the battery electrode sheet has the following advantages. First, the plurality of battery electrode sheets can be automatically sorted according to weight using the automatic weighing and sorting device. Furthermore, the automatic process eliminates damage to the battery electrode sheet, which may be caused from manually handling the battery electrode sheets. Moreover, because the plurality of battery electrode sheets can be automatically and accurately sorted and transferred to different sort stations, the consistency of the battery electrode sheets on the sort station can be improved. By adopting the microporous suction cup and the rotation device, the operation speed and production capacity can be improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and comprising the full extent established by the broad general meaning of the terms used in the claims. It will therefore be appreciated that the embodiments described above may be modified within the scope of the claims.

What is claimed is:

1. An apparatus useful for automatically weighing and sorting battery electrode sheets comprising:
a weighing device configured to measure a weight of each of a plurality of battery electrode sheets;
a conveying device configured to transfer the plurality of battery electrode sheets to the weighing device; and
assorting device configured to sort the plurality of battery electrode sheets based on the weight of each of the plurality of battery electrode sheets measured by the weighing device.

2. The apparatus of claim 1, wherein the sorting device comprises a microporous suction cup and an automatic control device; the microporous suction cup is configured to grip each of the plurality of battery electrode sheets using suction or at least a partial vacuum from the weighing device, and the automatic control device is configured to sort the plurality of battery electrode sheets into different sorting stations based on the weight measured by the weighing device.

3. The apparatus of claim 1, further comprising a suction device, wherein the suction device is configured to grip the plurality of battery electrode sheets and place the plurality of battery electrode sheets on the conveying device.

4. The apparatus of claim 1, wherein a weighing surface of the weighing device is at a lower altitude than a conveying surface of the conveying device.

5. The apparatus of claim 4, wherein a height difference between the weight surface and the conveying surface ranges from about 1 mm to about 10 mm.

6. The apparatus of claim 1, wherein the weighing device is spaced from the conveying device.

7. The apparatus of claim 6, wherein a distance between the weighing device and the conveying device ranges from about 1 mm to about 2 mm.

8. The apparatus of claim 1, wherein the conveying device comprises a first guide rail and a second guide rail perpendicular to the first guide rail.

9. The apparatus of claim 8, wherein a height of the conveying surface on the second guide rail tends to decrease along a conveying direction.

10. The apparatus of claim 9, wherein a slope angle between the transfer surface on the second guide rail and a horizontal plane ranges from about 150° to about 170°.

11. The apparatus of claim 8, wherein the second guide rail comprises a first end and a second end, the first end of the second guide rail is connected to the first guide rail, and the weighing device is located at the second end of the second guide rail and spaced from the second end of the second guide rail.

12. The apparatus of claim 1, wherein the sorting device comprises a column guide, a bracket, a microporous suction cup, a rotation device, and an automatic control device configured to sort the plurality of battery electrode sheets into different sorting stations based on the weight measured by the weighing device; a first end of the column guide is connected to and driven by the rotation device; the bracket is connected to a second end of the column guide, and capable of rotating with rotation of the column guide.

13. The apparatus of claim 12, wherein the bracket comprises a third end and a fourth end, the third end of the bracket is connected to the column guide, and the fourth end of the bracket is suspended above the weighing device.

14. The apparatus of claim 13, wherein the microporous suction cup is located on the fourth end of the bracket.

15. The apparatus of claim 13, wherein the plurality of sorting stations surround the rotation device.

16. The apparatus of claim 15, wherein a carrying surface of each of the sorting stations is at a lower altitude than a weighing surface of the weighing device.

17. The apparatus of claim 15, wherein the plurality of sorting station are integrated with the rotation device and capable of rotating with the rotation device.
